(19) United States
(12) Patent Application Publication
(10) Pub. No.: US 2010/0134879 A1
(43) Pub. Date: Jun. 3, 2010

(54) DISPLAY SCREEN PROTECTION FILM AND POLARIZATION PLATE

(76) Inventors: Masanori Yoshihara, Tokyo (JP); Tetsuya Toyoshima, Tokyo (JP); Jiro Ishihara, Tokyo (JP)

Correspondence Address: BIRCH STEWART KOLASCH & BIRCH, PO BOX 747, FALLS CHURCH, VA, 22040-0747, US

(21) Appl. No.: 12/597,317

(22) PCT Filed: Apr. 24, 2008
(86) PCT No.: PCT/JP2008/057920

§ 371 Date: Oct. 23, 2009

(30) Foreign Application Priority Data
Apr. 26, 2007 (JP) 2007-116322

(51) Int. Cl. G02B 5/22; B32B 5/00

(52) U.S. Cl. 359/361; 428/220

(57) ABSTRACT

The present invention is to provide a display screen protection film that exhibits uniform in-plane ultraviolet absorption property, excellent mechanical strength, flexibility, heat resistance and optical property, and to provide a polarization plate wherein the display screen protection film is used as a polarization plate protection film. The display screen protection film obtained by stretching 1.2 to 6 times a film having a thickness of 20 to 300 μm wherein an acrylic resin layer (B1) containing no ultraviolet light absorbing agent is disposed on one surface of an acrylic resin layer (A) containing the ultraviolet light absorbing agent, and an acrylic resin layer (B2) containing no ultraviolet light absorbing agent is disposed on another surface thereof.

### TECHNICAL FIELD

The present invention relates to a display screen protection film and a polarization film using the same, and particularly relates to a display screen protection film suitable for a polarization film protector having a uniform in-plane ultraviolet light absorption property, an excellent mechanical strength, flexibility, heat resistance and optical property, and a polarization film using this display screen protection film.

### BACKGROUND ART

On outmost surface of a display device such as LCD and PDP, a film for protecting a screen is sometimes disposed. Generally, such protection films applied therefor is in a form of functional films to which functions such as anti-reflective, antistatic and anti-fouling functions have been imparted. As display screen protection films that play a role of a support structure of these functional films, films composed of acrylic resins have been studied. However, a laminated film of an acrylic resin is inferior in mechanical strength. Thus such a film is brittle and has tendency to be cracked.

In order to solve this problem, there have been proposed stretching of a film of an acrylic resin having a lactone ring structure (Patent Document 1: International Publication WO2006/112207 (corresponding publication: EP1865346A1)), and biaxial stretching of a film composed of a copolymer of methyl methacrylate with N-alkyl maleimide or maleic anhydride (Patent Document 2: JP Hei-5-288929-A), aiming at obtaining an acrylic resin film that is excellent in heat resistance and mechanical strength with keeping the optical property intrinsic to the acrylic resin. However, the resins disclosed in these prior art documents have high rigidity, and thus are easily broken as a result of attempt to obtain a long film with a high stretch ratio.

It has been known that when a film composed of a certain type of an acrylic resin comprising acrylic elastic body particles is stretched, the stretch ratio can be increased to approximately 5 times (Patent Document 3: International Publication WO2005/105918 (corresponding publication: EP1754752A1)). However, addition of an increased amount of the elastic body particles causes a great extent of thermal shrinkage which leads to an insufficient reliability under a high temperature environment.

By the way, the display screen protection film is required to have ultraviolet light absorption property for the purpose of preventing elements used inside the display device from being deteriorated by ultraviolet light, in addition to transparency, light resistance, color tone, heat resistance, impact resistance and lightweight.

As a method for obtaining the display screen protection film that has excellent ultraviolet light absorption property, there is disclosed a method in which a resin layer containing an ultraviolet light absorbing agent is sandwiched with two resin layers containing no ultraviolet light absorbing agent to make a laminated film (Patent Document 4: JP 2007-017555-A).

### DISCLOSURE OF INVENTION

### Problem to be Solved by the Invention

It is an object of the present invention to provide a display screen protection film that has a uniform in-plane ultraviolet light absorption property, an excellent mechanical strength, flexibility, heat resistance and optical property. It is a further object of the present invention to provide a polarization film having the display screen protection film as a polarization film protection film.

The present inventors produced the laminated film having the resin layer containing the ultraviolet light absorbing agent described in Patent Document 4, and stretched the resulting film. As a result, they have found out that there was in-plane unevenness in the ultraviolet light absorption property within the film. Then, as a result of seeking for a method for reducing this unevenness, the present inventors have found out that adjustment of the thickness of the pre-stretch film in a predetermined range results in elimination of the unevenness in the ultraviolet light absorption property even when the film is stretched with the stretch ratio of 1.2 to 6 times, and thus completed the present invention. In particular, addition of elastic body particles to one or some of the layers constituting the laminated film (particularly an acrylic resin layer containing no ultraviolet light absorbing agent) results in not only reduced unevenness in the ultraviolet light absorption property but also good slip property, which renders the film suitable for producing a long film, thus being preferable.

### Means for Solving Problem

Thus according to the present invention, the following (1) to (6) are provided:

(1) A display screen protection film obtained by stretching with a stretching ratio of 1.2 to 6 times a film having a thickness of 20 to 300 μm, the film having an acrylic resin layer (A) containing the ultraviolet light absorbing agent, an acrylic resin layer (B1) containing no ultraviolet light absorbing agent disposed on one surface of the acrylic resin layer (A), and an acrylic resin layer (B2) containing no ultraviolet light absorbing agent disposed on another surface of the acrylic resin layer W.
(2) The display screen protection film according to (1),

wherein the thickness of the film after being stretched is not less than 15 μm and not more than 80 μm.

(3) The display screen protection film according to (1) or (2), wherein the amount of the ultraviolet light absorbing agent is 0.5 to 6 parts by weight based on 100 parts by weight of an acrylic resin that is a constituent of the acrylic resin layer (A).
(4) The display screen protection film according to any one of (1) to (3), wherein any one or two of the acrylic resin layers (A), (B1) and (B2) contain elastic body particles.
(5) The display screen protection film according to any one of (1) to (4), wherein the content of the elastic body particle is 20 to 150 parts by weight based on 100 parts by weight of an acrylic resin that is a constituent of the layer containing the elastic body particle.
(6) The display screen protection film according to (5) or (6), wherein the layer containing the elastic body particle is the acrylic resin layer (B1) and/or the acrylic resin layer (B2).
(7) A polarization plate obtained by laminating the display screen protection film according to any one of (1) to (6) onto a polarizer.

### BRIEF DESCRIPTION OF DRAWINGS

FIG. 1 is a plane view schematically showing measurement positions for determining a heat shrinkage ratio of a film.

### BEST MODE FOR CARRYING OUT THE INVENTION

The display screen protection film of the present invention is obtained by stretching a film having a structure in which an acrylic resin layer containing an ultraviolet light absorbing agent (A) (hereinafter this may simply be referred to as an “acrylic resin layer (A)”) and acrylic resin layers containing no ultraviolet light absorbing agent (B1) and (B2) (hereinafter these may collectively be referred to as an “acrylic resin layers (B)”) have been disposed so that the layer (A) is sandwiched by (B1) and (B2) (hereinafter this film may be referred to as a “pre-stretch film”).

The thickness of the pre-stretch film is 20 to 300 μm, preferably 20 to 200 μm and more preferably 40 to 100 μm. When the pre-stretch film is too thick, the bending property thereof tends to worsen, while when the film is too thin, control of the thickness of each layer becomes difficult and the handling property thereof is reduced.

Examples of the method for controlling the thickness may include a method of adjusting a gap of T-die slits, an extruding speed, a rotation speed of a cooling roll and a melting temperature, and a method of pressing the film during passing through the cooling roll with a pressure bonding roll. These methods may be applicable when the film is formed by a melt extrusion method, which will be described later. When the film is molded by a solution flow coating method, a method of adjusting a solid content concentration by changing a ratio of a diluent liquid upon preparing a solution may be applicable.

The acrylic resins that compose the acrylic resin layers (A), (B1) and (B2) may be the same or different. It is preferable that each resin has a light transmittance of 80% or more, more preferably 85% or more and still more preferably 90% or more in a visible light region of 400 to 700 nm when the resin layer has a thickness of 1 mm. The glass transition temperature of the acrylic resin is preferably 60 to 200° C. and more preferably 100 to 180° C. The glass transition temperature may be measured by differential scanning calorimetry analysis (DSC).

As the acrylic resin, a polymer resin obtained using (meth)acrylate ester as a main raw material is preferably used. This polymer resin may be a homopolymer composed of (meth)acrylate ester alone or a copolymer, and may be a copolymer of (meth)acrylate ester with a monomer copolymerizable therewith. (Meth)acrylic acid in the present invention means acrylic acid and/or methacrylic acid. Likewise, (meth)acrylate ester means acrylate ester and/or methacrylate ester.

(Meth)acrylate ester as the main raw material of the acrylic resin may preferably be those having a structure derived from (meth)acrylic acid and alkanol having 1 to 15 carbon atoms, and more preferably 1 to 8 carbon atoms. When alkanol has too many carbon atoms, elongation of the obtained film upon being broken sometimes becomes too large. The alkyl moiety of the alkanol may be straight or branched and may be a combination thereof.

Specific examples of this (meth)acrylate ester may include methyl acrylate, ethyl acrylate, n-propyl acrylate, i-propyl acrylate, n-butyl acrylate, i-butyl acrylate, sec-butyl acrylate, t-butyl acrylate, n-hexyl acrylate, cyclohexyl acrylate, n-octyl acrylate, 2-ethylhexyl acrylate, n-decyl acrylate, n-dodecyl acrylate, methyl methacrylate, ethyl methacrylate, n-propyl methacrylate, i-propyl methacrylate, n-butyl methacrylate, i-butyl methacrylate, sec-butyl methacrylate, t-butyl methacrylate, n-hexyl methacrylate, n-octyl methacrylate, 2-ethylhexyl methacrylate, n-decyl methacrylate and n-dodecyl methacrylate.

These (meth)acrylate esters may have any optional substituent such as hydroxyl groups and halogen atoms. Examples of (meth)acrylate ester having such a substituent may include 2-hydroxyethyl acrylate, 2-hydroxypropyl acrylate, 4-hydroxybutyl acrylate, 2-hydroxyethyl methacrylate, 2-hydroxypropyl methacrylate, 4-hydroxybutyl methacrylate, 3-chloro-2-hydroxypropyl methacrylate and glycidyl methacrylate. One species of these (meth)acrylate esters may be solely used, or two or more species thereof may be used in combination.

The acrylic resin used in the present invention contains the (meth)acrylate ester unit at preferably 50% by weight or more, more preferably 85% by weight or more, and particularly preferably 90% by weight or more.

The monomer copolymerizable with (meth)acrylate ester is not particularly limited. Examples thereof may include α,β-ethylenic unsaturated carboxylate ester monomers other than aforementioned (meth)acrylate esters, α,β-ethylenic unsaturated carboxylic acid monomers, alkenyl aromatic monomers, conjugate diene monomers, non-conjugate diene monomers, cyanized vinyl monomers, unsaturated carboxylic acid amide monomers, carboxylate unsaturated alcohol ester and olefin monomers.

Specific examples of the α,β-ethylenic unsaturated carboxylate ester monomers other than aforementioned (meth)acrylate esters may include dimethyl fumarate, diethyl fumarate, dimethyl maleate, diethyl maleate, dimethyl itaconate, monoethyl maleate and mono-n-butyl fumarate.

The α,β-ethylenic unsaturated carboxylic acid monomer may be any of monocarboxylic acid, polyvalent carboxylic acid and polyvalent carboxylic anhydride, and specific examples thereof may include acrylic acid, methacrylic acid, crotonic acid, maleic acid, fumaric acid, itaconic acid, maleic anhydride and itaconic anhydride.

Specific examples of the alkenyl aromatic monomer may include styrene, α-methylstyrene, methyl-α-methylstyrene, vinyl toluene and divinyl benzene.

Specific examples of the conjugate diene monomer may include 1,3-butadiene, 2-methyl-1,3-butadiene, 1,3-pentadiene, 2,3-dimethyl-1,3-butadiene, 2-chloro-1,3-butadiene and cyclopentadiene. Specific examples of the non-conjugate diene monomer may include 1,4-hexadiene, dicyclopentadiene and ethylidene norbornene.

Specific examples of the cyanized vinyl monomer may include acrylonitrile, methacrylonitrile, α-chloroacrylonitrile and α-ethylacrylonitrile.

Specific examples of α,β-ethylenic unsaturated carboxylic acid amide monomer may include acrylamide, methacrylamide, N-methylolacrylamide, N-methylolmethacrylamide and N,N-dimethylacrylamide.

Specific examples of the carboxylate unsaturated alcohol ester monomer may include vinyl acetate.

Specific examples of the olefin monomer may include ethylene, propylene, butene and pentene.

As the monomers copolymerizable with (meth)acrylate ester, one species thereof may be solely used, or two or more species may be used in combination. As the monomer copolymerizable with (meth)acrylate ester, alkenyl aromatic monomers are preferable. Among them, styrene is preferable.

The content of the unit of the monomer copolymerizable with (meth)acrylate ester in the acrylic resin used in the present invention is preferably 50% by weight or less, more preferably 15% by weight or less and still more preferably 10% by weight or less.

Preferable specific examples of the acrylic resin for the present invention may include polymethyl methacrylate (homopolymer of methyl methacrylate), methyl methacrylate/methyl acrylate/butyl acrylate/styrene copolymers, methyl methacrylate/methyl acrylate copolymers, and methyl methacrylate/styrene/butyl acrylate copolymers. In the present invention, among them, the polymer having a structure unit derived from methyl methacrylate (this unit may be referred to hereinafter as a “methyl methacrylate unit”) in an amount of 50% by weight or more (particularly 80% by weight or more) in all structure units is preferable, and polymethyl methacrylate is particularly preferable. As the acrylic resin, one species thereof may be solely used, or two or more species thereof may be used in combination.

The weight average molecular weight of the acrylic resin is not particularly limited, and is usually 50,000 to 500,000. When the weight average molecular weight is within this range, a homogenous film can be easily produced by the melt extrusion method.

The acrylic resin used for the present invention is preferably selected from those having a melt flow rate value ranging from 10 to 100 g/10 minutes (280° C., load: 2.16 kgf). When the pre-stretch film is formed by the melt extrusion method, it is preferable that the melt flow rate value of the thermoplastic resin that composes each layer is at the same level. Specifically, the difference in the melt flow rate values of the thermoplastic resins between the adjacent layers is preferably 0 to 30 g/10 minutes (280° C., load: 2.16 kgf).

It is particularly preferable that, among the layers that compose the laminated layer film of the present invention, the acrylic resin layer (A) is a layer formed from a material having Vicat softening point of 120° C. or higher and preferably 120 to 150° C. (the material is composed of the acrylic resin and optionally added additives), and that the acrylic resin layers (B1) and/or (B2) are the layers formed from a material having Vicat softening point of 95 to 115° C. and a tensile breaking strain of 15% or more (the material is composed of the acrylic resin and optionally added additives). In the present invention, Vicat softening point is a value measured under the conditions employed in the Examples.

Suitable examples of the acrylic resin having Vicat softening point of 120° C. or higher and preferably 120 to 150° C. may include methacrylate resins containing the methyl methacrylate unit and a structure unit derived from one or more compounds of N-alkyl maleimide, maleic anhydride and methacrylate ester compounds having an alicyclic hydrocarbon group having 5 to 22 carbon atoms in its ester moiety. The ratio of the structure unit other than the methyl methacrylate unit is 2 to 30% by weight and preferably 5 to 20% by weight based on the all structure units, for assuring the high heat resistance and an excellent molding property.

Among N-alkyl maleimides, effective are those having an alkyl moiety substituted with methyl or branched or cyclic alkyl group having 3 to 7 carbon atoms such as methyl, isopropyl, t-butyl and cyclohexyl groups. Those substituted with a normal alkyl group such as ethyl, n-propyl and n-butyl groups may sometimes be insufficient in the improvement of the heat resistance. Those N-substituted with an aromatic group may give a copolymer colored in yellow, which may not be a resin having the high light transmittance.

Examples of the alicyclic hydrocarbon group having 5 to 22 carbon atoms in the methacrylate ester compound having the alicyclic hydrocarbon group having 5 to 22 carbon atoms in its ester moiety may include cyclopentyl, cyclohexyl, norbornyl and tricyclo[5.2.1.0^{2,6}]deca-8-yl groups.

Suitable examples of the material having Vicat softening point of 95 to 115° C. may include those obtained by adding acrylic rubber particles having a multilayer structure to the acrylic resin having Vicat softening point of 120° C. or higher and preferably 120 to 150° C. aforementioned as the acrylic resin suitable for composing the acrylic resin layer (A). When the acrylic rubber particles having a multilayer structure are used, the tensile breaking strain can be adjusted to 15% or more without unnecessary reduction of Vicat softening point. The amount of the acrylic rubber particles having a multilayer structure to be added is preferably 20 to 60 parts by weight based on 100 parts by weight of the total amount of the methacrylic resin. When the amount of the rubber particles is too small, improvement of the tensile breaking strain may become insufficient, whereas, when the amount is too large, Vicat softening point may be remarkably reduced and sufficient heat resistance for a film may not be realized in some cases. The acrylic rubber particles having a multilayer structure may be produced by a publicly known method (e.g., JP SHO-57-200412-A). The tensile breaking strain of the acrylic resin that composes the acrylic resin layer (B) is suitably 15% or more. The tensile breaking strain is the value measured under the conditions employed in the Examples.

The acrylic resin containing the acrylic rubber particles having a multilayer structure is commercially available as impact resistant polymethyl methacrylate resins such as “Delpet SR” (product name, supplied from Asahi Kasei Chemicals Corporation).

The acrylic rubber particles having a multilayer structure referred to herein are one type of elastic body particles which will be described later.

The ultraviolet light absorbing agent contained in the acrylic resin layer (A) may be selected from those which are added to general resins. Examples thereof may include those publicly known such as oxybenzophenone-based compounds, benzotriazole-based compounds, salicylate ester-based compounds, benzophenone-based ultraviolet light absorbing agents, benzotriazole-based ultraviolet light absorbing agents, acrylonitrile-based ultraviolet light absorbing agents, triazine-based compounds, nickel complex salt-based compounds, and inorganic powders. Among them, preferable are benzotriazole-based compounds such as 2,2′-methylenebis(4-(1,1,3,3-tetramethylbutyl)-6-(2H-benzotriazole-2-yl)phenol) and 2-(2′-hydroxy-3′-tert-butyl-5′-methylphenyl)-5-chlorobenzotriazole; and oxybenzophenol-based compounds such as 2,4-di-tert-butyl-6-(5-chlorobenzotriazole-2-yl)phenol, 2,2′-dihydroxy-4,4′-dimethoxybenzophenone and 2,2′,4,4′-tetrahydroxybenzophenone. Among them, benzotriazole-based compounds are particularly preferable, and 2,2′-methylenebis(4-(1,1,3,3-tetramethylbutyl)-6-(2H-benzotriazole-2-yl)phenol) is more preferable.

Examples of the method for forming the acrylic resin layer (A) containing the ultraviolet light absorbing agent may include: (1) a method of mixing the ultraviolet light absorbing agent with the acrylic resin layer to form the layer with the mixture, (2) a method of forming the layer with a master batch for the acrylic resin layer containing the ultraviolet light absorbing agent at high concentration and another acrylic resin layer containing no ultraviolet light absorbing agent, and (3) a method of directly supplying the ultraviolet light absorbing agent to the melt resin upon melt extrusion of the acrylic resin layer (A) and forming the film using a biaxial extruder. In particular, it is preferable to employ the method (1) because thereby the unevenness in the concentration of the ultraviolet light absorbing agent in the acrylic resin layer (A) in the pre-stretch film is easily suppressed.

The amount of the ultraviolet light absorbing agent contained in the acrylic resin layer (A) is preferably 0.5 to 6 parts by weight, more preferably 0.5 to 5 parts by weight and still more preferably 1.0 to 5 parts by weight based on 100 parts by weight of the acrylic resin that composes the acrylic resin layer (A). By controlling the content of the ultraviolet light absorbing agent within the aforementioned range, it is possible to effectively shield the ultraviolet light without deteriorating the color tone of the display screen. In particular, when the display screen protection film of the present invention is used as the protection film for the polarization plate, the reduction of a polarization degree can be prevented for a long period of time. When the content of the ultraviolet light absorbing agent in the acrylic resin layer (A) is less than 0.5 parts by weight, the light transmittance at wavelength of 370 and 380 nm is increased and the polarization degree of the polarization plate may tend to be reduced.

In the present invention, one or two layers among the acrylic resin layers (A), (B1) and (B2) in the pre-stretch film may contain elastic body particles.

The elastic body particles used in the present invention are particles composed of a rubber elastic body. Examples of the rubber elastic body may include acrylate ester-based rubber polymers, rubber polymers composed mainly of butadiene, and ethylene-vinyl acetate copolymers. As the acrylate ester-based rubber polymer, there are some polymers composed mainly of butyl acrylate or 2-ethylhexyl acrylate. Among them, the acrylate ester-based rubber polymers composed mainly of butyl acrylate and the rubber polymers composed mainly of butadiene are preferable. The elastic body particles may be composed of two layered polymers, and representative examples thereof may include elastic body particles having layers forming a core-shell structure, wherein the layers are a grafted rubber elastic component of alkyl acrylate such as butyl acrylate and styrene, and a hard resin layer composed of a copolymer of polymethyl acrylate and/or methyl methacrylate with alkyl acrylate.

The elastic body particles used in the present invention may have a diameter of 2 μm or less, preferably 0.1 to 1 μm and more preferably 0.1 to 0.5 μm, in terms of the number average particle diameter of secondary particles dispersed in the acrylic resin. Even if a first particle diameter of the elastic body particles is small, when the number average particle diameter of the secondary particles formed by agglomeration is large, a haze (cloud degree) of a substrate film becomes too high and the light transmittance degree is reduced. When the number average particle diameter is too small, the flexibility may tend to be reduced.

In the present invention, it is preferable that a refractive index na(λ) of the elastic body particles at wavelength of 380 to 780 nm and a refractive index nb(λ) of the acrylic resin that becomes a matrix at wavelength of 380 to 780 nm satisfy a relationship of |na(λ)−nb(λ)≦0.05 and more preferably |na(λ)−nb(λ)|≦0.045. na(λ) and nb(λ) are mean values of main refractive indices at wavelength λ. When the value |na(λ)−nb(λ)| exceeds the aforementioned value, the transparency is likely impaired due to interface reflection caused by a refractive index difference on the interface.

The amount of the elastic body particles to be added is preferably 20 to 150 parts by weight and more preferably 20 to 60 parts by weight based on 100 parts by weight of the acrylic resin that composes the layer to which the elastic body particles are added. When the amount of the elastic body particles is too small, the slip property and the flexibility of the film may become insufficient, whereas when the amount is too large, the heat resistance may become inferior in some cases.

The elastic body particles may be contained in any layer of the acrylic resin layers (A), (B1) and (B2), but is preferably contained in the layers (B1) and/or (B2) in terms of easy taking up (good slip property) of the pre-stretch film and the post-stretch display screen protection film.

As the method for producing the pre-stretch film for use in the present invention, a melt extrusion formation method using a T-die is preferable in terms of excellent productivity and thickness accuracy. Employing this method, the resin composing each layer may be melted in each extruder and then laminated in a melted state. Then the resin may be extruded from the T-die to be in a sheet-shape. The resulting sheet may be taken up on a cooling roll, to thereby produce a laminated film without interval.

In addition to the aforementioned extrusion method, it is also possible to produce the laminated film by bonding the films composing each layer using an adhesive agent. Examples of the adhesive agent may include acrylic adhesive agents, urethane-based adhesive agents, polyester-based adhesive agents, polyvinyl alcohol-based adhesive agents, polyolefin-based adhesive agents, modified polyolefin-based adhesive agents, polyvinyl alkyl ether-based adhesive agents, rubber-based adhesive agents, ethylene-vinyl acetate-based adhesive agents, vinyl chloride-vinyl acetate-based adhesive agents, SEBS (styrene-ethylene-butylene-styrene block copolymer)-based adhesive agents, SIS (styrene-isoprene-styrene block copolymer)-based adhesive agents, ethylene-based adhesive agents such as ethylene-styrene copolymer, and acrylate ester-based adhesive agents such as ethylene-methyl (meth)acrylate copolymer and ethylene-ethyl (meth)acrylate copolymer. Among them, those that keep the predetermined elasticity after being cured are more preferable. Examples of such an adhesive agent may include SEBS-based adhesive agents, SIS-based adhesive agents and ethylene-vinyl acetate-based adhesive agents.

The average thickness of the layer composed of this adhesive agent is usually 0.01 to 30 μm and preferably 0.1 to 15 μm.

It is preferable that the unevenness in the thickness of each layer in the pre-stretch film for use in the present invention is within ±3%. By controlling the unevenness in the thickness within this range, the unevenness in the ultraviolet light absorption property of the display screen protection film of the present invention can be reduced. The unevenness in the thickness referred to herein is an unevenness in thickness measured in some points, with respect to the arithmetic mean value of the thickness calculated from the measured values. Specifically, the unevenness in the thickness is as described later in Example.

Examples of the procedures for controlling the unevenness in the thickness of each layer in the pre-stretch film within ±3% may include (1) covering with an enclosing member the production line from an opening of a dice to a cast roll to which an extruded sheet-shaped pre-stretch laminated body is initially adhered in a tight manner, (2) edge-pinning both ends of the film on a cast roll and performing an air blast on a second roll, and (3) making a distance between a die slip and a cast portion of the pre-stretch laminated body 200 mm or less.

The thickness of each layer before being stretched may be arbitrary selected, but is preferably 20 to 70 μm and more preferably 30 to 50 μm. When the thickness of the layer is too thick, the flexibility may be reduced. When the thickness of the layer is too thick, it may become difficult to uniformly distribute the ultraviolet light absorbing agent. The ratio of the thickness of the layers may also be arbitrary selected, but in terms of preventing a warp, it is preferable that the layer (B1) and the layer (B2) have the same thickness.

The display screen protection film of the present invention may be obtained by stretching the pre-stretch film to at least one direction.

A step of previously heating the pre-stretch film (preheating step) may be provided before stretching the pre-stretch film. In the preheating step, heating of the pre-stretch film may be performed by an oven-type heating apparatus, a radiation heating apparatus or immersion in a liquid. Among them, the oven-type heating apparatus is preferable. The heating temperature in the preheating step is usually (the stretching temperature-40° C.) to (the stretching temperature+20° C.) and preferably (the stretching temperature−30° C.) to (the stretching temperature+15° C.) The stretching temperature means a set temperature in the heating apparatus.

Stretching in the stretching step may be performed using apparatus such as a pantograph mode tenter in which chucks are linked with pantographs whereby a chuck interval is extended; a screw mode tenter in which chucks are driven with a screw-shaped axis and a chuck interval is extended by controlling a screw groove interval; and a linear motor mode tenter.

The method for stretching is not particularly limited, and any of publicly known method may be applicable. Specific examples of the method may include uniaxial stretch methods such as a method of uniaxially stretching in a lengthwise direction by utilizing the difference in peripheral velocities on rolls, and a method of uniaxially stretching in a crosswise direction using the tenter; as well as biaxial stretch methods such as a simultaneous biaxial stretch method of stretching in the crosswise direction by extending angle of guide rails simultaneously with stretching in the lengthwise direction by extending the interval of fixed clips, and a sequential biaxial stretch method of stretching in the lengthwise direction utilizing the difference in peripheral velocities on rolls and subsequently stretching in the crosswise direction by supporting its both ends with clips and using the tenter.

The stretching temperature is usually Tg to Tg+35° C., preferably Tg to Tg+20° C. wherein Tg is a glass transition temperature of the resin having the lowest glass transition temperature.

In the production method of the present invention, the temperature difference in the stretch step with respect to a central portion along a flow direction of the pre-stretch film is within ±1.5° C. and more preferably ±1° C. in regions on right and left sides from the central portion. By making a temperature difference in the right and left regions uniform, a stretch degree in the right and left regions may become uniform, which in tern leads to uniform thickness of the obtained protection film.

The ratio for stretching is 1.2 to 6 times, preferably 1.3 to 5 times and more preferably 2.0 to 3 times. When the stretch method is the sequential biaxial stretch method, it is preferable that the stretch ratio in the second stretch is smaller than the stretch ratio in the first stretch. Specifically, the stretch ratio of the second stretch may be 0.5 to 0.95 times the stretch ratio in the first stretch. The stretch ratio out of the aforementioned range may cause insufficient orientation, which may in turn cause insufficient refractive index anisotropy which may then result in insufficient expression of phase difference. The stretch ratio out of the aforementioned range may also cause breakage of the laminated body. The stretch ratio referred to herein indicates each stretch ratio in the lengthwise direction and in the crosswise direction when the biaxial stretch is performed. Usually, the lengthwise direction indicates a longitudinal direction and the crosswise direction indicates a width direction of the laminated body.

A step of relaxing the stretched film (thermal fixation step) may be provided after the step of stretching (stretch step). The relaxing temperature in the thermal fixation step is usually room temperature to the stretching temperature+30° C. and preferably the stretching temperature-40° C. to the stretching temperature+20° C. In the thermal fixation step, the film may also be kept at the stretching temperature, without particular setting of the temperature.

The display screen protection film of the present invention obtained by the stretching has the acrylic resin layer (A) after the stretching (referred to hereinafter as the acrylic resin layer (A′)), the acrylic resin layer (B1) after the stretching (referred to hereinafter as the acrylic resin layer (B1′)) and the acrylic resin layer (B2) after the stretching (referred to hereinafter as the acrylic resin layer (B2′)). The stretched film obtained in this manner may become a film in which the unevenness in the concentration of the ultraviolet light absorbing agent contained in the acrylic resin layer (A′) is reduced. Therefore, the display screen protection film of the present invention is the film without unevenness in the ultraviolet light absorption property.

The unevenness in the concentration of the ultraviolet light absorbing agent is measured by the following procedure.

First, an ultraviolet light transmittance is measured using a spectrophotometer. Subsequently, the thickness of the display screen protection film is measured by a contact mode thickness meter. Then, the cross-sectional surface of the measured portion is observed using an optical microscope, and the thickness ratio of the acrylic resin layers (B1′) (B2′) to the acrylic resin layer (A′) is obtained, on the basis of which the thickness of the acrylic resin layer (A′) is then obtained. The concentration of the ultraviolet light absorbing agent is calculated from the ultraviolet light transmittance and the thickness using the following formula (1).

C=−log₁₀(0.01T)/K/L (1)

wherein C represents the concentration of the ultraviolet light absorbing agent (% by weight), T represents the light transmittance (%), K represents a light absorption coefficient (−) and L represents the thickness of the laminated body (μm).

The aforementioned operation is performed in the lengthwise direction and the crosswise direction at every constant interval on the display screen protection film.

The arithmetic mean value of these measured values (n=3) is calculated, and this is designated as an average concentration Cₐᵥₑ. Among the measured concentrations C, the maximum value is designated as Cₘₐₓ and a minimum value is designated as Cₘᵢₙ. The unevenness is calculated from the following formulae.

Unevenness in concentration (%)=Larger one of (Cₐᵥₑ−Cₘᵢₙ)/Cₐᵥₑ×100 and (Cₘₐₓ−Cₐᵥₑ)/Cₐᵥₑ×100

In order to suppress the unevenness in the concentration of the ultraviolet light absorbing agent to 0.1% or less in the overall area of the acrylic resin layer (A′), it is important to design the thickness of the pre-stretch film in the aforementioned range. In addition, it is preferable to suppress the unevenness in the concentration of the ultraviolet light absorbing agent in the acrylic resin layer (A′) in the pre-stretch film. The unevenness in the concentration of the ultraviolet light absorbing agent in the acrylic resin layer (A) in the pre-stretch film may be suppressed by performing any of the following upon production of the pre-stretch film:

(1) the dried acrylic resin and the ultraviolet light absorbing agent are mixed, and the mixture is then placed in a hopper connected to the extruder and supplied to a uniaxial extruder to perform melt extrusion;

(2) the acrylic resin is placed in the hopper equipped with a dryer while the ultraviolet light absorbing agent is also placed therein via another inlet, and the acrylic resin and the ultraviolet light absorbing agent are then supplied to a biaxial extruder with weighing each material, to perform melt extrusion.

Further in the display screen protection film of the present invention, the light transmittance at wavelength of 380 nm is preferably 4% or less and more preferably 3% or less. In the film, the light transmittance at wavelength of 370 nm is preferably 1% or less and more preferably 0.5% or less. Further in the display screen protection film, the light transmittance at wavelength of 420 to 780 nm is preferably 85% or more and more preferably 90% or more.

When the light transmittance at wavelength of 380 nm or 370 nm of the display screen protection film exceeds the aforementioned range, the polarizer may be altered by the ultraviolet light and the polarization degree may be reduced when the film is mounted in, e.g., the display device such as the liquid crystal display device. The aforementioned light transmittance may be measured in accordance with JIS K 0115 using the spectrophotometer.

The surface roughness (Ra) of the acrylic resin layers (B1′) and/or (B2′) in the display screen protection film is preferably 8 to 30 nm and more preferably 10 to 20 nm. When the surface roughness is too small, the slip property of the protection film may sometimes be deteriorated, which may cause reduction in operability. For example, when the protection film is transferred in a roll to roll manner, the protection film may stick to the feeding rolls, which may sometimes cause wrinkles and brokage of the film. When the protection film is taken up as a roll, the protection film may be rubbed against one another to cause scratch marks, and air release between the protection films may be insufficient to thereby cause a deteriorated shape of the take-up roll.

Meanwhile when the surface roughness is too large, the transparency of the protection film tends to be reduced due to light scatter on the surface.

In the display screen protection film of the present invention, a haze inside the layer (internal haze that causes the scatter inside the layer) is usually approximately 0 to 1%, preferably 0 to 0.8% (e.g., 0.01 to 0.8%) and more preferably 0 to 0.5% (e.g., 0.1 to 0.5%). The internal haze may be determined by preparing a protection film on which a resin layer is coated for flattening surface asperity, or preparing a laminate wherein a smooth transparent film is attached to the surface asperity of the protection film through a transparent adhesive layer, and then measuring the haze of the preparation.

The external haze of the display screen protection film of the present invention is preferably 1.1 to 5.0%. Adjustment of the haze values within these ranges may improve adhesiveness to the polarization plate, whereby the clearness of the display device can be enhanced when the display screen protection film of the present invention is applied to the display device. The external haze may be measured in accordance with JIS K 7361-1997 using a haze meter (“NDH-300A” supplied from Nippon Denshoku Kogyo Co., Ltd.). In the present invention, the haze is measured 5 times, and the arithmetic mean value thereof is taken a representative value of the haze.

The display screen protection film of the present invention has a thermal shrinkage ratio of preferably 0.5% or less and more preferably 0.3% or less in the lengthwise direction and the crosswise direction after being treated with heat at 60° C. at 90% RH for 100 hours. When the thermal shrinkage ratio exceeds this range, the protection film is deformed and peeled off the display device due to a shrinkage stress when used under a high temperature and high humidity environment.

The display screen protection film of the present invention has YI (yellow index) in the range of preferably −2.0 to 3.0 and more preferably −2.0 to 2.0, that is an index indicating a degree of yellowishness. When YI exceeds 3.0, a color reproducibility of the display device is impaired due to the color of the film when the display screen protection film of the present invention is applied to the display device. YI may be measured by the method described in JIS K 7373: 2006.

In the display screen protection film of the present invention, the content of the residual solvent is preferably 0.01% by weight or less. Suppression of the content of the residual solvent within the aforementioned range may, e.g., prevent the film from deforming under the high temperature and high humidity environment, and prevent the film from deterioration in the optical property. The film in which the amount of the residual solvent is within the aforementioned range may be obtained by co-extrusion molding of the multiple resins. When molding is performed by the co-extrusion molding, complicated steps (e.g., drying step and coating step) may be omitted, whereby contamination of foreign matters from outside such as dusts can be reduced and resulting film can have excellent optical properties.

The content of the residual solvent is a value obtained by placing 50 mg of the substrate film in a sample container that is a glass tube having an internal diameter of 4 mm from which water and organic matters adhered onto its surface have been removed completely, heating the container at 200° C. for 30 minutes, continuously capturing gases released from the container and analyzing the captured gases using a thermal desorption gas chromatography mass spectrometer (TDS-GC-MS).

When the display screen protection film of the present invention is used as the protection film for the polarization plate, its water vapor permeability is preferably 10 g·m⁻² day⁻¹ or more, and 200 g·m⁻² day⁻¹ or less. By adjusting the water vapor permeability of the protection film within the aforementioned suitable range, the adhesion strength to the layer laminated on the display screen protection film can be enhanced. The water vapor permeability may be measured by a cup method described in JIS Z 0208 under the test conditions in which the film is left stand under the environment at 40° C. and 92% RH for 24 hours.

Further when the display screen protection film of the present invention is used as the protection film on a liquid crystal cell side of the polarization plate, it is preferable that the film is optically isotropic. Specifically, Re is preferably 10 nm or less and more preferably 5 nm or less. For Rth, its absolute value is preferably 10 nm or less and more preferably 5 nm or less.

The retardation in an in-plane direction Re and the retardation in a thickness direction Rth are values obtained by Re=(nx−ny)×d, Rth=[(nx+ny)/2−nz]×d wherein d is the thickness of the film (nm). In the formula, nx and ny represent an in-plane main refractive index (nx≧ny), nz represents a refractive index in the thickness direction, and d represents an average thickness.

In the display screen protection film of the present invention, an absolute value of its light elastic coefficient is preferably 30×10⁻¹² pa⁻¹ or less, more preferably 10×10⁻¹² Pa⁻¹ or less and still more preferably 5×10⁻¹² pa⁻¹ or less. When the light elastic coefficient is larger than the aforementioned value, the display screen protection film easily expresses the phase difference in response to the stress from the outside, and likely reduces the optical property.

The display screen protection film of the present invention may be provided with a functional layer generally employed for optical films such as a hard coat layer and a low refractive index layer.

The hard coat layer is a layer having a function of enhancing a surface hardness of the display screen protection film of the present invention, and may preferably be those exhibiting a hardness equal to or harder than H in a pencil hardness test (using a glass plate as a test plate) as defined in JIS K 5600-5-4. It is preferable that the display screen protection film provided with such a hard coat layer has a hardness being equal to or harder than 4H. The material that forms the hard coat layer (the hard coat material) is preferably a material curable with heat or light, and examples thereof may include organic hard coat materials such as organic silicone-based, melamine-based, epoxy-based, acrylic, urethane acrylate-based materials; and inorganic hard coat materials such as silicate dioxide. Among them, urethane acrylate-based and polyfunctional acrylate-based hard coat materials are preferable because of good adhesive force and high productivity.

If desired, the hard coat layer may contain various fillers for the purposes of adjusting the refractive index, enhancing a bending elastic modulus, stabilizing a volume shrinkage ratio, as well as enhancing the heat resistance, an antistatic property and an antiglare property. The hard coat layer may also contain additives such as antioxidants, ultraviolet light absorbing agents, light stabilizers, antistatic agents, leveling agents and anti-foam agents.

The antireflection layer is a layer for preventing formation of outside light image, and is laminated on the surface of the display screen protection film (surface exposed to the outside) directly or through another layer such as the hard coat layer.

The thickness of the antireflection layer is preferably 0.01 to 1 μm and more preferably 0.02 to 0.5 μm. Examples of the antireflection layer may include those composed of a low refractive index layer having a refractive index that is smaller than the refractive index of the layer to which the antireflection layer is laminated, specifically having a refractive index of 1.30 to 1.45; and those obtained by alternately laminating several layers of a thin film low refractive index layer composed of an inorganic compound and a thin film high refractive index layer composed of an inorganic compound.

The material for forming the low refractive index layer is not particularly limited as long as the refractive index is low. Examples thereof may include resin materials such as ultraviolet light-curable acrylic resins, hybrid materials in which inorganic fine particles are dispersed in a resin, and sol-gel materials using metal alkoxide such as tetraethoxysilane. These materials for forming the low refractive index layer may be polymerized polymers, or monomers or oligomers that are precursors. In order to impart a property for avoiding adhesion of stains, it is preferable that each material contains a fluorine-containing compound.

Examples of the fluorine-containing compound may include fluorine-containing polymers having crosslinking functional groups in addition to the sol-gel materials containing fluorine groups.

An example for the sol-gel materials containing the fluorine groups may be fluoroalkyl alkoxysilane. Fluoroalkyl alkoxysilane is a compound represented by, e.g., CF₃(CF₂)ₙCH₂CH₂Si(OR)₃ (wherein R represents an alkyl group having 1 to 5 carbon atoms, and n represents an integer of 0 to 12). Specific examples of fluoroalkyl alkoxysilane may include trifluoropropyl trimethoxysilane, trifluoropropyl triethoxysilane, tridecafluorooctyl trimethoxysilane, tridecafluorooctyl triethoxysilane, heptadecafluorodecyl trimethoxysilane and heptadecafluorodecyl triethoxysilane. Among them, compounds in which n is 2 to 6 are preferable.

The fluorine-containing polymers having a crosslinking functional group may be obtained by copolymerizing a fluorine-containing monomer with a monomer having a crosslinking functional group, or copolymerizing a fluorine-containing monomer with a monomer having a functional group and adding a compound having a crosslinking functional group to the functional group in the polymer.

Examples of the fluorine-containing monomer may include fluoroolefins such as fluoroethylene, vinylidene fluoride, tetrafluoroethylene, hexafluoroethylene, hexafluoropropylene and perfluoro-2,2-dimethyl-1,3-dioxole; derivatives of partially or completely fluorinated alkyl esters of (meth)acrylic acid and partially or completely fluorinated vinyl ethers, such as “Biscoat 6FM” (supplied from Osaka Organic Chemical IND Ltd.) and “M-2020” (supplied from Daikin Industries, Ltd.).

Examples of the monomer having a crosslinking functional group or the compound having a crosslinking functional group may include monomers having a glycidyl group such as glycidyl acrylate and glycidyl methacrylate; monomers having a carboxyl group such as acrylic acid and methacrylic acid; monomers having a hydroxyl group such as hydroxyalkyl acrylate and hydroxyalkyl methacrylate; methylol acrylate and methylol methacrylate; monomers having a vinyl group such as allyl acrylate and allyl methacrylate; monomers having an amino group; and monomers having a sulfonic acid group.

As the materials for forming the low refractive index layer, those containing the sol in which fine particles of silica, alumina, titania, zirconia or magnesium fluoride are dispersed in an alcohol solvent may be used for enhancing an anti-scratch property. The aforementioned fine particles having the lower refractive index are more preferable in terms of antireflection. Such fine particles may have voids. In particular, a silica hollow fine particle is preferable. The average particle diameter of the hollow fine particles is preferably 5 nm to 2,000 nm and more preferably 20 nm to 100 nm. The average particle diameter is the number average particle diameter obtained by observation under a transmission electron microscope.

It is preferable that the low refractive index layer has coefficient of dynamic friction (JIS K 7125) of preferably 0.03 to 0.15 and a contact angle against water (JIS R 3257) of preferably 90 to 120 degrees.

Further, the functional layer may be a general optional layer such as an antifouling layer, an antiglare layer, a gas barrier layer, a transparent antistatic layer, a primer layer, an electromagnetic wave shielding layer or an undercoating layer, that is employed for the optical film other than the aforementioned layers.

The display screen protection film of the present invention may be used as the surface protection film of a display device such as liquid crystal display devices (LCD), plasma display panels (PDP), electroluminescence display (ELD), cathode ray tube display devices (CRT), field emission displays (FED), electronic papers and touch panels, by directly bonding thereto, or by replacing a surface member incorporated in the display device such as a polarization plate protection film or a front plate. The display screen protection film of the present invention is used suitably for protecting the polarization plate.

When the display screen protection film of the present invention is used as a polarization plate protection film, the polarization plate is obtained by bonding the film on one surface of a polarizer via an adhesive agent, and then curing the adhesive agent to fix the film onto the polarizer.

Prior to bonding the polarizer to the display screen protection film, the surface of the film for bonding may be subjected to a treatment for facilitating the adhesion such as a saponification treatment, a corona treatment, a primer treatment or an anchor coating treatment.

Examples of the polarizer may include those obtained by preparing a polyvinyl alcohol film which has absorbed iodine or a dichroic dye, and then uniaxially stretching the film in a boric acid bath; and those obtained by preparing a polyvinyl alcohol film which has absorbed iodine or a dichroic dye, stretching the film, and further modifying a portion of the polyvinyl alcohol unit in the molecular chain to a polyvinylene unit. As the polarizer, a polarizer having a function of separating the polarized light into reflected light and transmitted light, such as a grid polarizer, a multilayer polarizer and a cholesteric liquid crystal polarizer, may also be used. Among them, the polarizer containing polyvinyl alcohol is preferable. The polarization degree of the polarizer is preferably 98% or more and more preferably 99% or more. The thickness (average thickness) of the polarizer is preferably 5 to 80 μm.

After bonding the polarizer on one surface of the display screen protection film, usually a protection layer is formed on another surface of the polarizer that is not in contact with the film. The protection layer may be the display screen protection film of the present invention or may be a protection layer conventionally used for the polarization plate, such as those composed of a polycarbonate resin, a polyether sulfone resin, a polyethylene terephthalate resin, a polyimide resin, polymethyl methacrylate resin, a polysulfone resin, a polyarylate resin, a polyethylene resin, a polystyrene resin, a polyvinyl chloride resin, cellulose ester and an alicyclic olefin polymer.

The method of laminating the protection film on the polarizer is not particularly limited. For example, a general method in which the protection film for the protection layer is laminated on the polarizer via, if necessary, an adhesive agent may be employed. As the adhesive agent for bonding the protection layer on the polarizer, publicly known adhesive agents may be used.

Using this polarization plate, a liquid crystal display device may be produced. The liquid crystal display device usually includes a light source, the polarization plate on an incident side, a liquid crystal cell and the polarization plate on an emission side, disposed in this order. The polarization plate may be provided on the emission side (visual observation side) and/or on the incident side (light source side) in the device, but it is preferable to dispose the polarization plate of the present invention at least on the emission side. The liquid crystal display device may further comprise a phase difference plate, a luminance enhancing film, an optical waveguide, a light diffusion plate, a light diffusion sheet, a light collecting sheet and a reflection plate.

### EXAMPLES

Subsequently, the present invention will be described in more detail with reference to Examples and Comparative Examples. Parts and % are based on the weight unless otherwise specified.

Protection films obtained in Examples and Comparative Examples were evaluated by the following methods.

### (Tests/Evaluation Methods)

<Tensile Elastic Modulus>

A single layer of a resin was formed to obtain a film having a thickness of 100 μm test piece of 1 cm×25 cm was cut out, and its tensile elastic modulus was measured in accordance with ASTM D 882 using a tensile tester (Tensilon UTM-10T-PL supplied from Toyo Baldwin Co., Ltd.) under the condition at a tensile speed of 25 mm/minute. The same measurement was performed five times, and their arithmetic mean value was taken as a representative value of the tensile elastic modulus.

<Vicat Softening Point>

A test piece was made and Vicat softening point of the resin was measured in accordance with JIS K 6717-2.

<Tensile Breaking Strain>

A test piece was made and the tensile breaking strain of the resin was measured in accordance with JIS K 6717-2. When a sample is broken without being yielded, the tensile breaking strain was measured, while when the sample is broken after being yielded, a measured value of a pre-strain upon tensile breaking was taken as the tensile breaking strain.

### <Film Thickness>

A pre-stretch film was embedded in an epoxy resin, and sliced using a microtome (RUB-2100, supplied from Yamato Kogyo Co., Ltd.). A cross section thereof was observed using a scanning electron microscope, and the thickness of each layer was measured.

For measuring the thickness of the protection film, the protection film was embedded in an epoxy resin, and sliced using a microtome (RUB-2100, supplied from Yamato Kogyo Co., Ltd.). A cross section thereof was observed using a scanning electron microscope, and the thickness of the entire film was measured.

<Surface Roughness>

Surface roughness Ra of the film was measured using an atomic force microscope (scanning type probe microscope). Using the scanning type probe microscope (SPI3800 series) supplied from Seiko Instruments Inc., the surface of the film in the range of 30 μm square was scanned and measured in a dynamic force mode, and an arithmetic mean value which is an equivalent to Re defined in JIS B 0601 was obtained from the obtained profile curve of the surface. The magnification in the in-plane direction was set to 10,000 to 50,000 times, and the magnification in the height direction was set to approximately one million times.

The following physical properties of the stretched films (In Comparative Example 2, pre-stretch film) were measured.

### <Re and Rth>

Re and Rth at a wavelength of 550 nm were measured using a high speed spectroellipsometer (M-2000U, supplied from J. A. Woollam). The same measurements were performed in the width direction of the protection film in 10 points with equal intervals, and a mean value was calculated.

### <Shrinkage Ratio>

A test piece of a regular tetragon having each side length of 150 mm was cut out from a center portion in the width direction of the film.

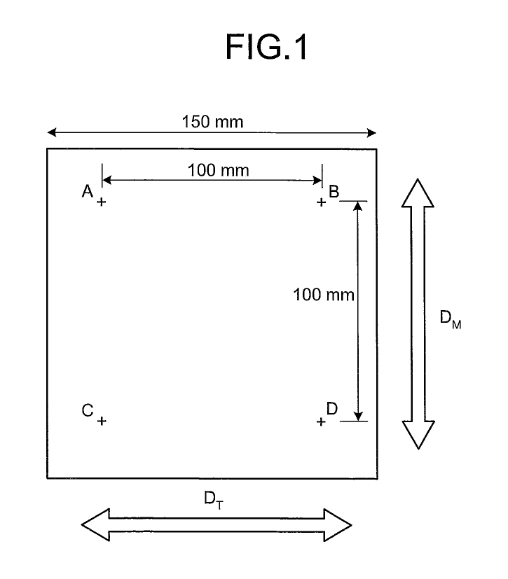

Reference points (A to D) were provided at positions each of which is 25 mm distant from each apex toward a center of the regular tetragon in a width direction (direction shown by an arrow D_{T} in FIG. 1) and in a length direction (direction shown by an arrow D_{M} in FIG. 1). Each of the distances from A to B, from C to D, from A to C and from B to D is 100 mm. After keeping this test piece at a temperature of 60° C. and at 90% RH for 100 hours, displacement of the reference point intervals ΔAB, ΔCD, ΔAC and ΔBC (100−distance [mm] after keeping for 100 hours) was measured. From the measured values, the shrinkage ratio in the width direction (ΔLtd) and the shrinkage ratio in the length direction (ΔLmd) were calculated by the following formulae.
Cf. FIG. 1.

ΔLtd={(ΔAB/100)+(ΔCD/100)}/2×100

ΔLmd={(ΔAC/100)+(ΔBD/100)}/2×100

<Internal Haze and External Haze>

Haze of the stretched film with a CIE standard 65 light source was measured using a turbidity meter (NDH 2000H, supplied from Nippon Denshoku Kogyo Co., Ltd.) (H0). Then, an acrylate monomer was applied on both surfaces of the stretched film, and cured to smooth the surface. Subsequently, haze was measured again and this value was taken as an internal haze value (Hi). An external haze (He) attributed to surface scatter is a value calculated from the following formula.

He=H0−Hi

<Ultraviolet Light Transmittance at Wavelength of 380 nm>

Ultraviolet light transmittance is measured in accordance with JIS K 0115 (spectrophotometry general rules) using an ultraviolet visible near-infrared spectrophotometer (V-570, supplied from JASCO Corporation).

<Color>

Color is measured using a spectro-mode color-difference meter (SE2000, supplied from Nippon Denshoku Kogyo Co., Ltd.) and using a CIE standard C light source. The same measurements are performed five times, and their arithmetic mean value is taken as YI.

<Coefficient of Friction>

A coefficient of static friction was measured in accordance with JIS K 7125. As another test piece that is placed below, an SUS304 plate of mirror finish was used.

<Water Vapor Permeability>

Water vapor permeability was measured under a test condition in which the film was left stand under the environment at 40° C. and 92% RH for 24 hours by a cup method in accordance with JIS Z 0208. The unit for the water vapor permeability is g·m⁻² day⁻¹.

The following evaluations were performed for the stretched films (In Comparative Example 2, pre-stretch film)

### <Slip Property>

Winding gap and winding wrinkle of the edge face of the film that had been taken up were visually observed.

Good: Neither winding gap nor winding wrinkle is observed.
Medium: Either winding gap or winding wrinkle is observed.
Poor: Both winding gap and winding wrinkle are observed.

<Bending Property>

A manipulation in which a film of 300 mm square was folded along a diagonal line toward both directions was alternately repeated 100 times. Evaluation was made in a following manner by an optical microscope for confirming whether there were microcracks in the film or not.

Good: No change
Medium: Slight microcracks occur on the edge face, but this is not practically problematic.
Poor: The microcracks occur along a folded line.

Protection films with a hard coat layer and an antireflection layer were evaluated as follows.

### <Pencil Hardness>

The surface of the protection film with the antireflection layer (surface of antireflection layer) was scratched at a length of approximately 5 mm at five points with a 2H pencil in accordance with JIS K 5600-5-4, except that a load was 500 g, and the degree of the given scar was confirmed.

Superior: No scar was given.
Good: The scar was given at one point.
Poor: The scars were given at two or more points.

Polarization plates were evaluated as follows.

### <Light Resistance>

The produced polarization plate was exposed under the conditions of irradiation with a sunshine carbon arc lamp and at a relative humidity of 60% for 200 hours using a sunshine weather meter (S-80, supplied from Suga Test Instruments Co., Ltd.). Subsequently, hue unevenness in the polarization plate was visually observed and evaluated in accordance with the following indicators.

Good: No coloration is observed on the entire surface.
Poor: The coloration is partially observed.

<Adhesiveness of Polarization Plate>

Five polarization plates having a size of 10 cm×10 cm were cut out. Then the plate was subjected to an operation wherein the plate was left stand in a constant-temperature and constant humidity room at 80° C. and at 95% RH for 24 hours, and then left stand in a constant-temperature and constant-humidity room at 20° C. and at 40% RH for 24 hours. The operation was repeated 20 times. The state of the laminate between the layers in the protection layer and between the polarizer and the protection layer were visually observed and evaluated in accordance with the following criteria.

Superior: No peeled polarization plate.
Good: One peeled polarization plate.
Poor: Two or more peeled polarization plates.

<Warp>

A polarization plate having the size of 10 cm×10 cm was cut out, and the test piece was left stand in the incubator at 60° C. and at 90% RH for 500 hours. After removing the test piece from the incubator, the test piece was placed on a horizontal plate, and a curled state of the test piece was evaluated. The curling property was evaluated in accordance with the following criteria.

Superior: No curl is observed, and good.
Good: Slight curl is observed although this is scarcely noticeable.
Poor: Apparent curl is observed and practically problematic.

<Clearness>

Letters were displayed on a reorganized liquid crystal display device, and clearness of the contour of the letters was visually observed and evaluated in accordance with the following criteria.

Superior: The letter contour is clear and no blur is observed.
Good: The blur of the contour is observed, but is not troublesome.
Poor: The letter is whitish, and the blur of the contour is observed.

<Luminance Defect>

The polarization plate was incorporated in the commercially available liquid crystal display device. White image was displayed on the device and the presence or absence of luminescent spots and luminescent lines was visually confirmed.

Good: Neither the luminescent spot nor the luminescent line is confirmed, and the visibility is good.
Poor: The luminescent spot and/or the luminescent line is observed, and observers feel discomfort.

<Frame Failure>

Among the polarization plates and the viewing angle compensation film that sandwich the liquid crystal cell in a commercially available liquid crystal monitor (IPS mode, 20V model), the polarization plate and a viewing angle compensation film disposed on a visual side were peeled off. The polarization plate and the protection film obtained in Examples and Comparative Examples were bonded to the liquid crystal cell instead so that the protection film faces the observer.

The reassembled liquid crystal monitor was left stand in the incubator at temperature of 60° C. and humidity of 90% for 500 hours. Black image was displayed on the monitor, and the state of the polarization plate on the observer side after being left stand was visually observed.

Good: No light leakage is observed throughout the polarization plate.
Poor: Light leakage is observed in the edge region of the polarization plate.

### Production Example

### Preparation of Multilayer Structure Acrylic Elastic Body Particles A

In a reactor equipped with a stirrer and a condenser, 6860 mL of distilled water and 20 g of sodium dioctylsulfosuccinate as an emulsifier were placed. The temperature was raised up to 75° C. under a nitrogen atmosphere with stirring to obtain a distilled water with the emulsifier under the state with no effect of oxygen.

To this distilled water with the emulsifier, a mixed solution composed of 220 g of methyl methacrylate (hereinafter abbreviated as MMA), 33 g of n-butyl acrylate, 0.8 g of allyl methacrylate (hereinafter abbreviated as ALMA) and 0.2 g of diisopropylbenzene hydroperoxide (hereinafter abbreviated as PBP) was added. The mixture was kept at 80° C. for 15 minutes to polymerize a first layer.

Subsequently, to the reaction solution in which the polymerization of the first layer had been completed, a mixed solution composed of 1270 g of n-butyl acrylate, 320 g of styrene, 20 g of diethylene glycol acrylate, 13.0 g of ALMA and 1.6 g of PBP was continuously added dropwise over one hour. After finishing the addition, the reaction was further proceeded for 40 minutes to polymerize a second layer.

Then, for the polymerization of a third layer, a mixed solution composed of 340 g of MMA, 2.0 g of n-butyl acrylate, 0.3 g of PBP and 0.1 g of n-octylmercaptan was added to the reaction solution in which the polymerization of the second layer had been completed, and further a mixed solution composed of 340 g of MMA, 2.0 g of n-butyl acrylate, 0.3 g of PBP and 1.0 g of n-octylmercaptan was added. Subsequently, the temperature was raised up to 95° C. and kept for 30 minutes to obtain latex of multilayer structure acrylic rubber particles. A small amount of the latex was collected, and its number average particle diameter was measured by an absorbance method. The diameter was found out to be 200 μm.

The latex thus obtained was added to an aqueous solution of 0.5% aluminium chloride to agglomerate the polymer, which was then washed five times with warm water and dried, to obtain multilayer acrylic elastic body particles A.

<Preparation of Acrylic Resin 1>

80 Parts by weight of an acrylic resin “Delpet 80 NH” (brand name, supplied from Asahi Kasei Chemicals Corporation; methyl methacrylate/methyl acrylate copolymer: Vicat softening point 118° C., tensile elastic modulus 3.3 GPa) and 20 parts by weight of the multilayer acrylic elastic body particles A were mixed. The mixture was melted and kneaded at 260° C. using a biaxial extruder, to obtain an elastic body particle-containing acrylic resin 1 (hereinafter abbreviated as R-PMMA1).

Vicat softening point and the tensile elastic modulus of the elastic body particle-containing acrylic resin 1 were 102° C. and 2.5 GPa, respectively.

<Preparation of Acrylic Resin 2>

An elastic body particle-containing acrylic resin 2 (R-PMMA2) was obtained in the same manner as in the elastic body particle-containing acrylic resin 1, except that the amount of the added multilayer elastic body particle A was changed to 80 parts by weight.

Vicat softening point and the tensile elastic modulus of the elastic body particle-containing acrylic resin 2 were 90° C. and 1.5 GPa, respectively.

<Preparation of Acrylic Resin 3>

An acrylic resin composed of methyl methacrylate/styrene/maleic anhydride copolymer (product name: “Delpet 980N” supplied from Asahi Kasei Chemical; Vicat softening point 125° C., tensile elastic modulus 3.5 GPa, in this resin, approximately 10% by weight of a maleic anhydride unit had been copolymerized) and an ultraviolet light absorbing agent (LA31, brand name, supplied from ADEKA Corporation) were mixed so that the concentration of the ultraviolet light absorbing agent was 5% by weight, to obtain an acrylic resin 3 (PMMA1).

<Preparation of Acrylic Resin 4>

An acrylic resin 4 (PMMA2) was obtained in the same manner as in the method for producing the acrylic resin 3, except that an acrylic resin “Delpet 80 NH” was used in place of “Delpet 980N”.

<Preparation of Material for Forming Hard Cost Layer>

30 Parts of hexafunctional urethane acrylate oligomer, 40 parts of butyl acrylate, 30 parts of isoboronyl methacrylate and 10 parts of 2,2-diphenylethane-1-one were mixed using a homogenizer, and a solution of 40% antimony pentoxide fine particles (average particle diameter: 20 nm, a hydroxyl group was bound to one antimony atom that appeared on the surface of a pyrochlore structure) in methyl isobutyl ketone was admixed therewith at a ratio in which the weight of the antimony pentoxide fine particles occupied 50% by weight in the total solid content of the composition for forming the hard coat layer, to thereby prepare a material for forming the hard coat layer.

<Preparation of Material for Forming Low Refractive Index Layer>

70 Parts by weight of vinylidene fluoride and 30 parts by weight of tetrafluoroethylene which are fluorine-containing monomers were dissolved in methyl isobutyl ketone. Subsequently, to the mixture, hollow silica isopropanol dispersion sol (supplied from JGC Catalysts and Chemicals Ltd., solid content 20% by weight, average primary particle diameter: approximately 35 nm, outer shell thickness: approximately 8 nm) was added in the amount of 30% by weight as the hollow silica solid content relative to the aforementioned solid content of the fluorine-containing monomer. Dipentaerythritol hexaacrylate (supplied from Shin-Etsu Chemical Co., Ltd) was also added in the amount of 3% by weight relative to the aforementioned solid content. A light radical generator, Irgacure 184 (Ciba Specialty Chemicals) was also added in the amount of 5% by weight relative to the aforementioned solid content. Thereby a material for forming the low refractive index layer was prepared.

The refractive indices of the hard coat layer and the low refractive index layer were measured using a high speed spectroellipsometer (M-2000U, supplied from J. A. Woollam). Under the conditions of temperature at 20° C.±2° C. and humidity at 60±5%, spectra in a wavelength region of 400 to 1000 nm were measured with incident angles of 55, 60 and 65 degrees, and the refractive index was calculated from these measurement results.

<Production of Polarizer>

A polyvinyl alcohol film having a refractive index of 1.545 at wavelength of 380 nm, a refractive index of 1.521 at wavelength of 780 nm and a thickness of 75 μm was uniaxially stretched 2.5 times, immersed in an aqueous solution containing 0.2 g/L of iodine and 60 g/L of potassium iodine at 30° C. for 240 seconds. Then the film was immersed in an aqueous solution containing 70 g/L of boric acid and 30 g/L of potassium iodine and simultaneously uniaxially stretched 6.0 times and kept for 5 minutes. Finally by drying at room temperature for 24 hours, a polarizer P having an average thickness of 30 μm and a polarization degree of 99.95% was obtained.

### Example 1

### 1-1: Preparation of Protection Film

The elastic body particle-containing acrylic resin 1 was placed in a double flight type uniaxial extruder equipped with leaf disc-shaped polymer filters having an opening of 10 μm, and the melted resin at temperature of 260° C. at an outlet of the extruder was supplied to one inlet of a multimanifold die having a die slip with a surface roughness Ra of 0.1 μm.

Meanwhile, the acrylic resin 3 was introduced into a double flight type uniaxial extruder equipped with leaf disc-shaped polymer filters having an opening of 10 μm, and the melted resin at temperature of 260° C. at an outlet of the extruder was supplied to another inlet of the multimanifold die having the die slip with a surface roughness Ra of 0.1 μm.

Using the multilayer co-extruder of two type three layers, the melted acrylic resin 1 and acrylic resin 3 from the multimanifold at 260° C. were discharged in a sheet-shape from a T-type dice having a width of 700 mm and a slit gap of 1 mm, and the sheet is cooled with taking up by a metal roll at 100° C. at a speed of approximately 10 m/minute to obtain a pre-stretch film 1 composed of a three layer constitution of (R-PMMA1 layer (10 μm))-(PMMA1 layer (60 μm))-(R-PMMA1 layer (10 μm)).

The pre-stretch film 1 was uniaxially stretched 2.5 times along its crosswise direction at a stretching temperature of 145° C. using a tenter stretching machine, to obtain a protection film 1 having an average thickness of 30 μm. The surface roughness of the protection film 1 was 18 nm. Values of physical properties of the protection film 1 are shown in Table 2.

### 1-2: Preparation of laminated body of (antireflection layer)-(hard coat layer)-(protection film)

A corona discharge treatment was given to both surfaces of the protection film 1 using a high frequency transmitter (output power: 0.8 KW) to adjust the surface tension to 0.055 N/m. Subsequently, the material for forming a hard coat layer was coated on one surface of this stretched film using a die coater at a coating speed of 20 m/minute under an environment of temperature at 25° C. and humidity at 60% RH, and dried in a drying furnace at 80° C., to obtain a coating. This coating was irradiated with ultraviolet light (integral irradiation amount: 300 mJ/cm²) to form a hard coat layer having a thickness of 6 μm, to obtain a laminated body L11 composed of the protection film 1 and the hard coat layer.

Subsequently, the material for forming the low refractive index layer was coated on the surface of the hard coat layer of the laminated body L11 using a wire bar coater at a coating speed of 20 m/minute under an environment of temperature at 25° C. and humidity at 60% RH, and then dried by leaving stand at room temperature. The obtained coating was treated with heat at 120° C. under an oxygen atmosphere, and then irradiated with ultraviolet light under conditions of output power at 160 W/cm and an irradiation distance of 60 mm to form a low refractive index layer (refractive index: 1.37) having a thickness of 100 nm, to obtain a laminated body L12 in which (antireflection layer)-(hard coat layer)-(protection film 1) were laminated in this order.

### 1-3: Preparation of Polarization Plate

25 mL/m² of a solution of 1.5 mol/L potassium hydroxide in isopropyl alcohol was applied on one surface of a triacetylcellulose film having a thickness of 80 μm, and dried at 25° C. for 5 seconds. After washing for 10 seconds with running water, the surface of the film was dried by blowing air at 25° C., to obtain a protection film 0 that is a triacetylcellulose film to only one surface of which the saponification treatment was given.

A polyvinyl alcohol-based adhesive agent was applied to both surfaces of the polarizer P. The surface of the protection film 0 to which the saponification treatment had been given and the surface of the laminated body L12 having the protection film 1 were directed to the polarizer P, and they were bonded by a roll-to-roll method to obtain a polarization plate 1.

### Example 2

A protection film 2 was obtained in the same manner as in Example 1 (1-1), except that the stretch ratio was 1.5 times. The surface roughness of the protection film 2 was 16 nm. A polarization plate 2 was obtained in the same manner as in Example 1 (1-2) and (1-3), except that the protection film 2 was used in place of the protection film 1.

### Example 3

A protection film 3 was obtained in the same manner as in Example 1 (1-1), except that the acrylic resin 4 was used in place of the acrylic resin 3. The surface roughness of the protection film 3 was 18 nm. A polarization plate 3 was obtained in the same manner as in Example 1 (1-2) and (1-3), except that the protection film 3 was used in place of the protection film 1.

### Example 4

A protection film 4 was obtained in the same manner as in Example 1 (1-1), except that the acrylic resin 2 was used in place of the acrylic resin 1. The surface roughness of the protection film 4 was 20 nm. A polarization plate 4 was obtained in the same manner as in Example 1 (1-2) and (1-3), except that the protection film 4 was used in place of the protection film 1.

### Example 5

The multimanifold die that had been used in Example 1 for obtaining the film composed of two types three layers was replaced with a multimanifold die for obtaining a film composed of three type three layers. Acrylic resin 1, acrylic resin 3 and acrylic resin “Delpet 80 NH” (hereinafter referred to as PMMA simply) from the multimanifold at 260° C. in a melted state were discharged in a sheet-shape from the T-type dice having a width of 700 mm and a slit gap of 1 mm, and the sheet was cooled with taking up by the metal roll at 100° C. at a speed of approximately 10 m/minute, to obtain a pre-stretch film 4 composed of a three layer constitution of (a layer of R-PMMA1 (10 μm))-(a layer of PMMA1 (60 μm))-(PMMA layer (10 μm)).

A protection film 5 was obtained in the same manner as in Example 1 (1-1), except that the pre-stretch film 4 was used in place of the pre-stretch film 1. The protection film 5 had a surface roughness on the surface of the R-PMMA1 layer being 18 nm and a surface roughness on the surface of the PMMA layer being 5 nm.

A polarization plate 5 was obtained in the same manner as in Example 1 (1-2) and (1-3), except that the protection film 5 was used in place of the protection film 1 and the hard coat layer and the antireflection layer were formed on the surface of the PMMA layer of the protection film 5.

### Example 6

A protection film 6 was obtained in the same manner as in Example 1 (1-1), except that the stretching temperature was 150° C. and the stretch ratio was 1.3 times. The surface roughness of the protection film 6 was 15 nm. A polarization plate 6 was obtained in the same manner as in Example 1 (1-2) and (1-3), except that the protection film 6 was used in place of the protection film 1.

### Comparative Example 1

A protection film 7 was obtained by extruding and molding the acrylic resin 1 in a form of a single layer and uniaxially stretching the layer 2.5 times along its crosswise direction at stretching temperature of 145° C. The surface roughness of the protection film 7 was 18 nm. A polarization plate 7 was obtained in the same manner as in Example 1 (1-2) and (1-3), except that the protection film 7 was used in place of the protection film 1.

### Comparative Example 2

A protection film 8 was obtained in the same manner as in Example 1 (1-1), except that the thickness of the pre-stretch film was changed to (a layer of R-PMMA1 (5 μm))-(a layer of PMMA1 (20 μm))-(a layer of R-PMMA1 (5 μm)) and the stretch was not performed. The surface roughness of the protection film 8 was 15 nm. A polarization plate 8 was obtained in the same manner as in Example 1 (1-2) and (1-3), except that the protection film 8 was used in place of the protection film 1.

Concerning the film thickness of the pre-stretch film, the physical properties and their evaluation of the film after being stretched (protection film before forming the hard coat layer and the antireflection layer), the evaluation of the protection film with the hard coat layer and the antireflection layer and the evaluation of the polarizer, their results are shown below.

TABLE 1

| | | | Example | | | | | | Comp. Ex | |
|---|---|---|---|---|---|---|---|---|---|---|
| | | | 1 | 2 | 3 | 4 | 5 | 6 | 1 | 2 |
| Protection film | | | 1 | 2 | 3 | 4 | 5 | 6 | 7 | 8 |
| Acrylic resin layer B1 | Consitutent | | R- | R- | R- | R- | PMMA | R- | — | R- |
| (equivalent) | resin | | PMMA1 | PMMA1 | PMMA1 | PMMA2 | | PMMA | | PMMA1 |
| | Tensile | [GPa] | 2.5 | 2.5 | 2.5 | 1.5 | 3.3 | 2.5 | — | 2.5 |
| | elastic | | | | | | | | | |
| | modulus | | | | | | | | | |
| | Vicat | [° C.] | 102 | 102 | 102 | 90 | 110 | 102 | — | 102 |
| | softening | | | | | | | | | |
| | point | | | | | | | | | |
| | Tensile | [%] | 20 | 20 | 20 | 50 | 6 | 20 | — | 20 |
| | breaking | | | | | | | | | |
| | strain | | | | | | | | | |
| | Film | [μm] | 10 | 10 | 10 | 10 | 10 | 10 | — | 5 |
| | thickness | | | | | | | | | |
| Acrylic resin layer A | Constituent | | PMMA1 | PMMA1 | PMMA2 | PMMA1 | PMMA1 | PMMA1 | R- | PMMA1 |
| (equivalent) | resin | | | | | | | | PMMA1 | |
| | Tensile | [GPa] | 3.5 | 3.5 | 3.3 | 3.5 | 3.5 | 3.5 | 2.5 | 3.5 |
| | elastic | | | | | | | | | |
| | modulus | | | | | | | | | |
| | Vicat | [° C.] | 125 | 125 | 110 | 125 | 125 | 125 | 102 | 125 |
| | softening | | | | | | | | | |
| | point | | | | | | | | | |
| | Tensile | [%] | 5 | 5 | 6 | 5 | 6 | 5 | 20 | 5 |
| | breaking | | | | | | | | | |
| | strain | | | | | | | | | |
| | Film | [μm] | 60 | 60 | 60 | 60 | 60 | 60 | 80 | 20 |
| | thickness | | | | | | | | | |
| Acrylic resin layer B2 | Constituent | | R- | R- | R- | R- | R- | R- | — | R- |
| (equivalent) | resin | | PMMA1 | PMMA1 | PMMA1 | PMMA2 | PMMA1 | PMMA1 | | PMMA1 |
| | Tensile | [GPa] | 2.5 | 2.5 | 2.5 | 1.5 | 2.5 | 2.5 | — | 2.5 |
| | elastic | | | | | | | | | |
| | modulus | | | | | | | | | |
| | Vicat | [° C.] | 102 | 102 | 102 | 90 | 102 | 102 | — | 102 |
| | softening | | | | | | | | | |
| | point | | | | | | | | | |
| | Tensile | [%] | 20 | 20 | 20 | 50 | 20 | 20 | — | 20 |
| | breaking | | | | | | | | | |
| | strain | | | | | | | | | |
| | Film | [μm] | 10 | 10 | 10 | 10 | 10 | 10 | — | 5 |
| | thickness | | | | | | | | | |

TABLE 2

| | | | Example | | | | | | Comp. Ex. | |
|---|---|---|---|---|---|---|---|---|---|---|
| | | | 1 | 2 | 3 | 4 | 5 | 6 | 1 | 2 |
| Prodiction | Stretch | | Crosswise | Crosswise | Crosswise | Crosswise | Crosswise | Crosswise | Crosswise | No |
| conditions | | | | | | | | | | stretch |
| | Temperature | [° C.] | 145 | 145 | 145 | 145 | 145 | 150 | 145 | — |
| | Stretch | | 2.5 | 1.5 | 2.5 | 2.5 | 2.5 | 1.3 | 2.5 | — |
| | ratio | | | | | | | | | |
| | Thickness | [μm] | 30 | 50 | 30 | 30 | 30 | 60 | 30 | — |
| | after | | | | | | | | | |
| | stretch | | | | | | | | | |
| Properties | Re | [nm] | 7.3 | 3.4 | 5.0 | 7.0 | 7.0 | 1.5 | 4.0 | 0.4 |
| | Rth | [nm] | −6.2 | −6.8 | −4.0 | −6.0 | −6.0 | −5.0 | −2.0 | −2.6 |
| | Shrinkage | [%] | 0.15/ | 0.12/ | 0.20/ | 0.17/ | 0.14/ | 0.04/ | 0.6/ | 0.10/ |
| | ratio | | 0.25 | 0.20 | 0.35 | 0.30 | 0.22 | 0.07 | 0.7 | 0.15 |
| | Internal | [%] | 0.27 | 0.27 | 0.27 | 0.30 | 0.25 | 0.27 | 1.20 | 0.04 |
| | haze | | | | | | | | | |
| | Externel | [%] | 5.03 | 3.48 | 5.00 | 6.00 | 2.50 | 1.90 | 5.00 | 0.04 |
| | haze | | | | | | | | | |
| | Transmittance | [%] | <5 | <5 | <5 | <5 | <5 | <5 | <5 | <5 |
| | (380 nm) | | | | | | | | | |
| | Color | | 1.7 | 1.8 | 1.5 | 1.9 | 1.0 | 0.3 | 2.5 | 0.5 |
| | Friction | | 0.25 | 0.25 | 0.25 | 0.23 | 0.25 | 0.25 | 0.25 | 0.4 |
| | coefficient | | | | | | | | | |
| | Water | [g/m² · | 130 | 80 | 120 | 150 | 120 | 70 | 213 | 106 |
| | vapor | day] | | | | | | | | |
| | permeability | | | | | | | | | |

TABLE 3

| | | Example | | | | | | Comp. Ex. | |
|---|---|---|---|---|---|---|---|---|---|
| | | 1 | 2 | 3 | 4 | 5 | 6 | 1 | 2 |
| Film | Slip | Good | Good | Good | Good | Good | Good | Good | Good |
| evaluation | property | | | | | | | | |
| | Bending | Good | Good | Good | Good | Good | Good | Good | Poor |
| | property | | | | | | | | |
| | Pencil | Good | Good | Good | Good | Superior | Good | Poor | Good |
| | hardness | | | | | | | | |
| Polarization | Light- | Good | Good | Good | Good | Good | Good | Good | Poor |
| plate evaluation | resistance | | | | | | | | |
| | Adhesion | Good | Good | Good | Good | Good | Good | Good | Poor |
| | Warp | Good | Good | Good | Good | Good | Good | Poor | Good |
| | Clearness | Good | Good | Good | Good | Good | Good | Poor | Good |
| | Luminance | Good | Good | Good | Good | Good | Good | Good | Poor |
| | defect | | | | | | | | |
| | Frame | Good | Good | Good | Good | Good | Good | Poor | Good |
| | failure | | | | | | | | |

From these results, it has been found out that the polarization plate obtained using the protection film in Examples 1 to 6 according to the present invention is an excellent display screen protection film having a high light resistance without luminescent spot that causes problems in appearance. Further, it has also been found out that the display screen protection film of the present invention causes small heat shrinkage and enables high clearness, and therefore the display screen protection film of the present invention gives a polarization plate that is excellent in heat resistance and optical property. On the contrary, the protection film obtained from the pre-stretch acryl laminated body (Comparative Example 2) resulted in an insufficient bending property, and, when this film was incorporated as the polarization plate protection film and the light resistance test was performed, color change was observed on the polarization plate after the test. The polarization plate using the protection film obtained by stretching the single layer acrylic resin containing the ultraviolet light absorbing agent (Comparative Example 1) resulted in warp and frame failure after the heat resistance test, and resulted in low clearness and insufficient optical properties.

1. A display screen protection film obtained by stretching with a stretching ratio of 1.2 to 6 times a film having a thickness of 20 to 300 μm, the film having an acrylic resin layer (A) containing the ultraviolet light absorbing agent, an acrylic resin layer (B1) containing no ultraviolet light absorbing agent disposed on one surface of the acrylic resin layer (A), and an acrylic resin layer (B2) containing no ultraviolet light absorbing agent disposed on another surface of the acrylic resin layer (A).

2. The display screen protection film according to claim 1, wherein the thickness of the film after being stretched is not less than 15 μm and not more than 80 μm.

3. The display screen protection film according to claim 1, wherein the amount of the ultraviolet light absorbing agent is 0.5 to 6 parts by weight based on 100 parts by weight of an acrylic resin that is a constituent of the acrylic resin layer (A).

4. The display screen protection film according to claim 1, wherein any one or two of the acrylic resin layers (A), (B1) and (B2) contain elastic body particles.

5. The display screen protection film according to claim 4, wherein the content of the elastic body particle is 20 to 150 parts by weight based on 100 parts by weight of an acrylic resin that is a constituent of the layer containing the elastic body particle.

6. The display screen protection film according to claim 4, wherein the layer containing the elastic body particle is the acrylic resin layer (B1) and/or the acrylic resin layer (B2).

7. A polarization plate obtained by laminating the display screen protection film according to claim 1 onto a polarizer.
